(19) United States
(12) Patent Application Publication
(10) Pub. No.: US 2026/0128033 A1
(43) Pub. Date: May 7, 2026

(54) REAL-TIME VOICE GENERATOR SYSTEM WITH ARTIFICIAL INTELLIGENCE

(71) Applicant: BitHuman Inc, SAN FRANCISCO, CA (US)

(72) Inventors: Mehmet Efe Akengin, EL Cerrito, CA (US); Steve Gu, Lafayette, CA (US)

(73) Assignee: BitHuman Inc, SAN FRANCISCO, CA (US)

(21) Appl. No.: 18/935,602

(22) Filed: Nov. 3, 2024

(51) Int. Cl. G10L 13/027; G10L 13/033; G10L 13/08

(52) U.S. Cl. CPC G10L 13/027; G10L 13/033; G10L 13/08

(57) ABSTRACT

Embodiments of the present disclosure may include a real-time voice generator system with generative artificial intelligence (AI), including a processor.

### BACKGROUND OF THE INVENTION

Embodiments of the present disclosure may include a real-time voice generator system with generative artificial intelligence (AI).

### BRIEF SUMMARY

Embodiments of the present disclosure may include a real-time voice generator system with generative artificial intelligence (AI), including a processor. Embodiments may also include a multi-modal user interface input unit coupled to the processor. In some embodiments, the multi-modal user interface input unit may be configured to receive various types of inputs.

In some embodiments, the various types of inputs may include one or more of a first set of characteristics. In some embodiments, the one or more of the first set of characteristics may include text prompts, voice personality descriptions, images, existing voice samples, documents and websites, videos, and multi-language personality profiles.

In some embodiments, the text prompts may be configured to describe desired voice characteristics. In some embodiments, the voice personality descriptions may be configured to describe one or more of a second set of characteristics. In some embodiments, the one or more of the second set of characteristics may include tone, pitch, accent, and gender.

In some embodiments, the documents and websites may be configured to match voice to content tone in the documents and websites. In some embodiments, the various types of inputs may include contextual inputs such as language, intonation, and mood to further refine the generated voice. Embodiments may also include a real-time voice synthesis engine coupled to the processor.

In some embodiments, the real-time voice synthesis engine may be configured to analyze the various types of inputs and apply a generative AI model to synthesize a synthesized voice based on the various types of inputs. In some embodiments, the real-time voice synthesis engine may be configured to create novel voice outputs by manipulating fundamental voice characteristics.

In some embodiments, the processor may be configured to transform the synthesized voice into an audio file or stream for real-time or post-generation playback. In some embodiments, the synthesized voice may be configured to be customized and fine-tuned real-time based on user feedback and changing requirements. Embodiments may also include a voice persona creation engine coupled to the processor.

In some embodiments, the voice persona creation engine may be configured to define comprehensive voice profiles based on utility, objective, target audience, and tone.

Embodiments may also include a voice mixing engine coupled to the processor. In some embodiments, the voice mixing engine may be configured to mix and combine multiple high-quality base voices from multiple characters.

Embodiments may also include a vector embedding system coupled to the processor. In some embodiments, the vector embedding system may be configured to make precise adjustments to voice parameters. Embodiments may also include an observable voice system coupled to the processor. In some embodiments, the observable voice system coupled to the processor may be configured to enable real-time monitoring and modification of voice outputs. Embodiments may also include a feedback mechanism that adjusts the generated voice based on user corrections or preferences provided after an initial voice may be synthesized. In some embodiments, the synthetic voice can be integrated into multimedia applications, virtual assistants, or live interactions with users in real-time. In some embodiments, the synthesized voice may be automatically optimized for different output devices, including mobile, desktop, and smart speakers.

Embodiments of the present disclosure may also include a method with generative artificial intelligence (AI)for generating a synthetic voice from various types of inputs from one or more users receiving the various types of inputs from the one or more users via an user interface. In some embodiments, the various types of inputs may include one or more of a first set of characteristics.

In some embodiments, the one or more of the first set of characteristics may include text prompts, voice personality descriptions, images, existing voice samples, documents and websites, videos and multi-language personality profiles. In some embodiments, the text prompts may be configured to describe desired voice characteristics.

In some embodiments, the voice personality descriptions may be configured to describe one or more of a second set of characteristics. In some embodiments, the one or more of the second set of characteristics may include tone, pitch, accent, and gender. In some embodiments, the documents and websites may be configured to match voice to content tone in the documents and websites.

In some embodiments, the various types of inputs may include contextual inputs such as language, intonation, and mood to further refine the generated voice. Embodiments may also include processing the various types of input through a generative AI model trained on a plurality of voices. Embodiments may also include generating a synthetic voice based on the various types of inputs.

In some embodiments, the synthesized voice may be configured to be customized and fine-tuned real-time based on user feedback and changing requirements on the fly. In some embodiments, the synthetic voice could come from combing multiple high-quality base voices from multiple characters by the generative AI model. Embodiments may also include outputting the generated voice in an audio format.

In some embodiments, the voice synthesis engine integrates voice cloning techniques to imitate or blend existing voices with newly synthesized elements. In some embodiments, the method with generative artificial intelligence (AI)for generating a synthetic voice from various types of inputs from one or more users may include utilizing natural language processing algorithms to infer implicit voice characteristics from complex user prompts.

Embodiments of the present disclosure may also include a real-time voice generator system with generative artificial intelligence (AI), including a processor.

Embodiments may also include a multi-modal user interface input unit coupled to the processor. In some embodiments, the multi-modal user interface input unit may be configured to receive various types of inputs.

In some embodiments, the various types of inputs may include one or more of a first set of characteristics. In some embodiments, the one or more of the first set of characteristics may include text prompts, voice personality descriptions, images, existing voice samples, documents and websites, videos, and multi-language personality profiles.

Embodiments may also include a real-time voice synthesis engine coupled to the processor. In some embodiments, the real-time voice synthesis engine may be configured to analyze the various types of inputs and apply a generative AI model to synthesize a synthesized voice based on the various types of inputs. In some embodiments, the real-time voice synthesis engine may be configured to create novel voice outputs by manipulating fundamental voice characteristics. In some embodiments, the processor may be configured to transform the synthesized voice into an audio file or stream for real-time or post-generation playback. Embodiments may also include a feedback mechanism that adjusts the generated voice based on user corrections or preferences provided after an initial voice may be synthesized. In some embodiments, the synthetic voice can be integrated into multimedia applications, virtual assistants, or live interactions with users in real-time. In some embodiments, the synthesized voice may be automatically optimized for different output devices, including mobile, desktop, and smart speakers.

### BRIEF DESCRIPTION OF THE FIGURES

FIG. 1 is a block diagram illustrating a real-time voice generator system, according to some embodiments of the present disclosure.

FIG. 2 is a block diagram further illustrating the real-time voice generator system from FIG. 1, according to some embodiments of the present disclosure.

FIG. 3 is a flowchart illustrating a method, according to some embodiments of the present disclosure.

FIG. 4 is a block diagram illustrating a real-time voice generator system, according to some embodiments of the present disclosure.

FIG. 5 is a block diagram further illustrating the real-time voice generator system from FIG. 4, according to some embodiments of the present disclosure.

FIG. 6 is a diagram showing a first example of a method according to some embodiments of the present disclosure.

FIG. 7 is a diagram showing a second example of a method for providing according to some embodiments of the present disclosure.

FIG. 8 is a diagram showing a third example of a method according to some embodiments of the present disclosure.

FIG. 9 is a diagram showing a fourth example of a method according to some embodiments of the present disclosure.

FIG. 10 is a diagram showing a fifth example of a method according to some embodiments of the present disclosure.

### DETAILED DESCRIPTION

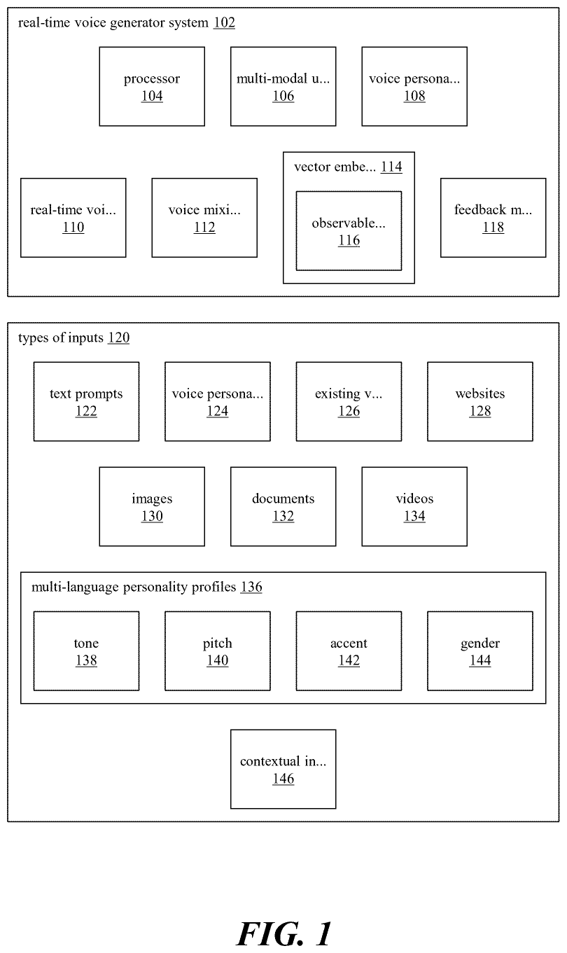

FIG. 1 is a block diagram that describes a real-time voice generator system 102, according to some embodiments of the present disclosure. In some embodiments, the real-time voice generator system 102 may include a processor 104, a multi-modal user interface input unit 106 coupled to the processor 104, a real-time voice synthesis engine 110 coupled to the processor 104, a voice persona creation engine 108 coupled to the processor 104, a voice mixing engine 112 coupled to the processor 104, a vector embedding system 114 coupled to the processor 104, and a feedback mechanism 118 that adjusts the generated voice based on user corrections or preferences provided after an initial voice may be synthesized.

In some embodiments, the multi-modal user interface input unit 106 may be configured to receive various types of inputs 120. The real-time voice synthesis engine 110 may be configured to analyze the various types of inputs 120 and apply a generative AI model to synthesize a synthesized voice based on the various types of inputs 120. The real-time voice synthesis engine 110 may be configured to create novel voice outputs by manipulating fundamental voice characteristics.

In some embodiments, the processor 104 may be configured to transform the synthesized voice into an audio file or stream for real-time or post-generation playback. The synthesized voice may be configured to be customized and fine-tuned real-time based on user feedback and changing requirements. The voice may persona creation engine may be configured to define comprehensive voice profiles based on utility, objective, target audience, and tone.

In some embodiments, the voice mixing engine 112 may be configured to mix and combine multiple high-quality base voices from multiple characters. The vector embedding system 114 may include an observable voice system 116 coupled to the processor 104. The vector embedding system 114 may be configured to make precise adjustments to voice parameters. The observable voice system 116 coupled to the processor 104 may be configured to enable real-time monitoring and modification of voice outputs.

In some embodiments, the types of inputs 120 may include text prompts 122, voice personality descriptions 124, images 130, existing voice samples 126, documents 132, websites 128, videos 134, and multi-language personality profiles 136. The types of inputs 120 may also include contextual inputs 146 such as language, intonation, and mood to further refine the generated voice. One or more of a first set of characteristics.

In some embodiments, the one or more of the first set of characteristics. The multi-language personality profiles 136 may include tone 138, pitch 140, accent 142, and gender 144. The text prompts 122 may be configured to describe desired voice characteristics. The voice personality descriptions 124 may be configured to describe one or more of a second set of characteristics. The one or more of the second set of characteristics. The documents 132 and websites may be configured to match voice to content tone in the documents 132 and websites. In some embodiments, the synthetic voice can be integrated into multimedia applications, virtual assistants, or live interactions with users in real-time.

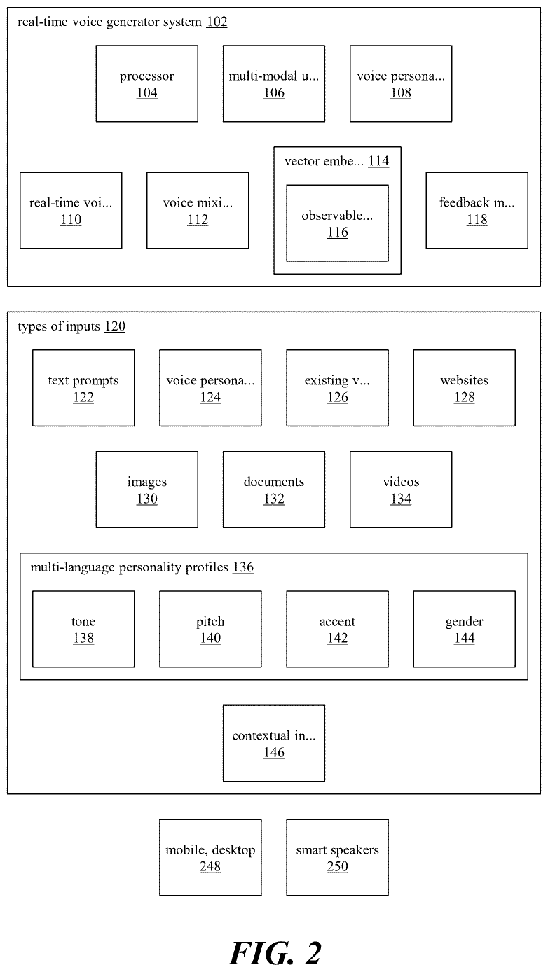

FIG. 2 is a block diagram that further describes the real-time voice generator system 102 from FIG. 1, according to some embodiments of the present disclosure. In some embodiments, the synthesized voice may be automatically optimized for different output devices. The different output devices can be mobile or desktop 248 or smart speakers 250.

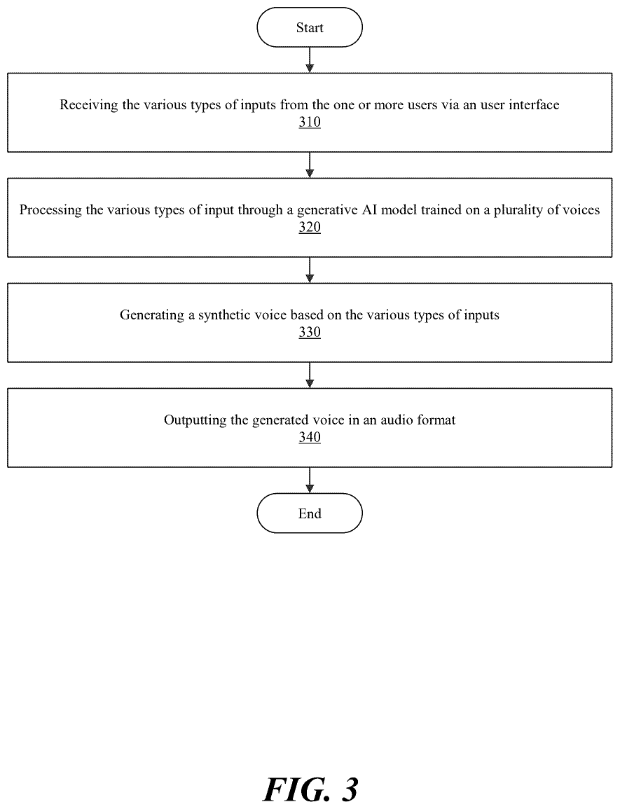

FIG. 3 is a flowchart that describes a method, according to some embodiments of the present disclosure. In some embodiments, at 310, the method may include receiving the various types of inputs from the one or more users via an user interface. At 320, the method may include processing the various types of input through a generative AI model trained on a plurality of voices. At 330, the method may include generating a synthetic voice based on the various types of inputs. At 340, the method may include outputting the generated voice in an audio format.

In some embodiments, the various types of inputs may comprise one or more of a first set of characteristics. The one or more of the first set of characteristics may comprise text prompts, voice personality descriptions, images, existing voice samples, documents and websites, videos and multi-language personality profiles. The text prompts may be configured to describe desired voice characteristics. The voice personality descriptions may be configured to describe one or more of a second set of characteristics.

In some embodiments, the one or more of the second set of characteristics comprise tone, pitch, accent, and gender. The documents and websites may be configured to match voice to content tone in the documents and websites. The various types of inputs may comprise contextual inputs such as language, intonation, and mood to further refine the generated voice. The synthesized voice may be configured to be customized and fine-tuned real-time based on user feedback and changing requirements on the fly. The synthetic voice could come from combing multiple high-quality base voices from multiple characters by the generative AI model. In some embodiments, the voice synthesis engine integrates voice cloning techniques to imitate or blend existing voices with newly synthesized elements. In some embodiments, the method with generative artificial intelligence (AI)for generating a synthetic voice from various types of inputs from one or more users.

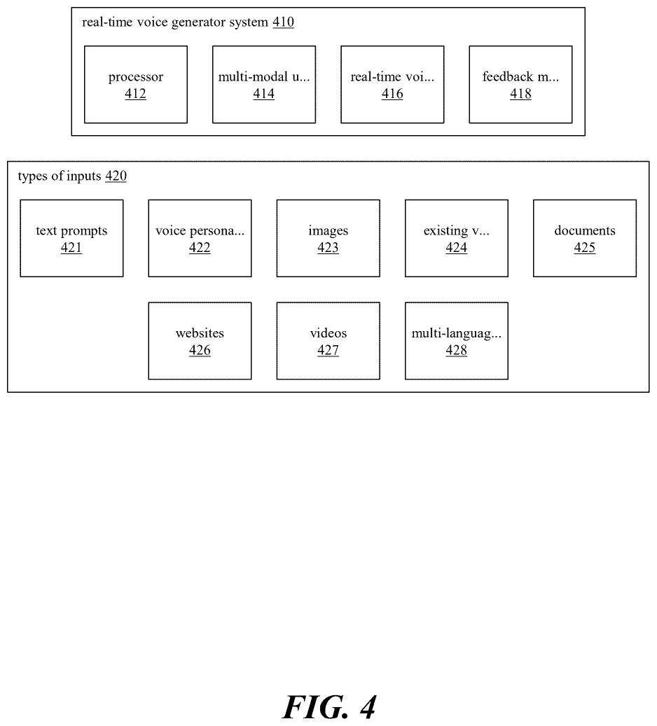

FIG. 4 is a block diagram that describes a real-time voice generator system 410, according to some embodiments of the present disclosure. In some embodiments, the real-time voice generator system 410 may include a processor 412, a multi-modal user interface input unit 414 coupled to the processor 412, a real-time voice synthesis engine 416 coupled to the processor 412, and a feedback mechanism 418 that adjusts the generated voice based on user corrections or preferences provided after an initial voice may be synthesized. The multi-modal user interface input unit 414 may be configured to receive various types of inputs 420.

In some embodiments, the real-time voice synthesis engine 416 may be configured to analyze the various types of inputs 420 and apply a generative AI model to synthesize a synthesized voice based on the various types of inputs 420. The real-time voice synthesis engine 416 may be configured to create novel voice outputs by manipulating fundamental voice characteristics. The processor 412 may be configured to transform the synthesized voice into an audio file or stream for real-time or post-generation playback. The types of inputs 420 may include text prompts 421, voice personality descriptions 422, images 423, existing voice samples 424, documents 425, websites 426, videos 427, and multi-language personality profiles 428. One or more of a first set of characteristics. The one or more of the first set of characteristics. In some embodiments, the synthetic voice can be integrated into multimedia applications, virtual assistants, or live interactions with users in real-time.

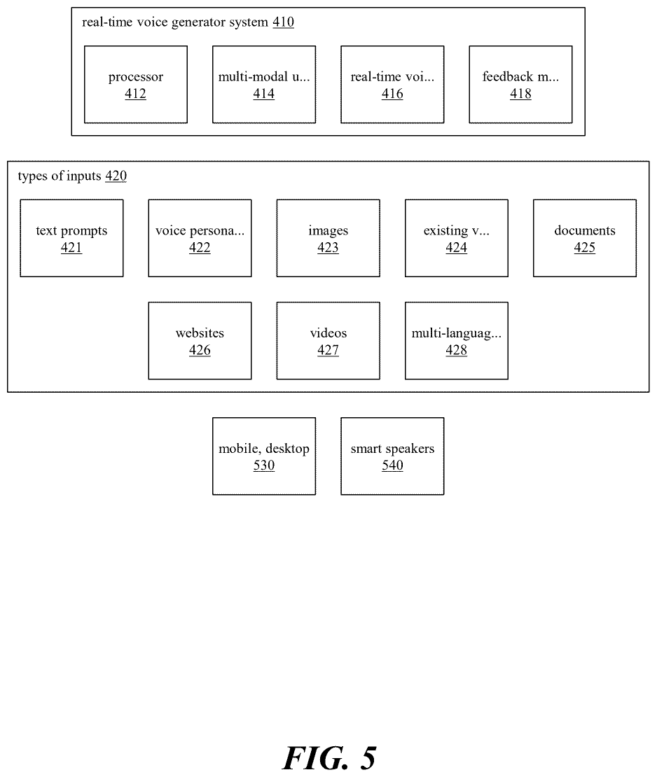

FIG. 5 is a block diagram that further describes the real-time voice generator system 410 from FIG. 4, according to some embodiments of the present disclosure. In some embodiments, the synthesized voice may be automatically optimized for different output devices. The different output devices can be mobile or desktop 530 or smart speakers 540.

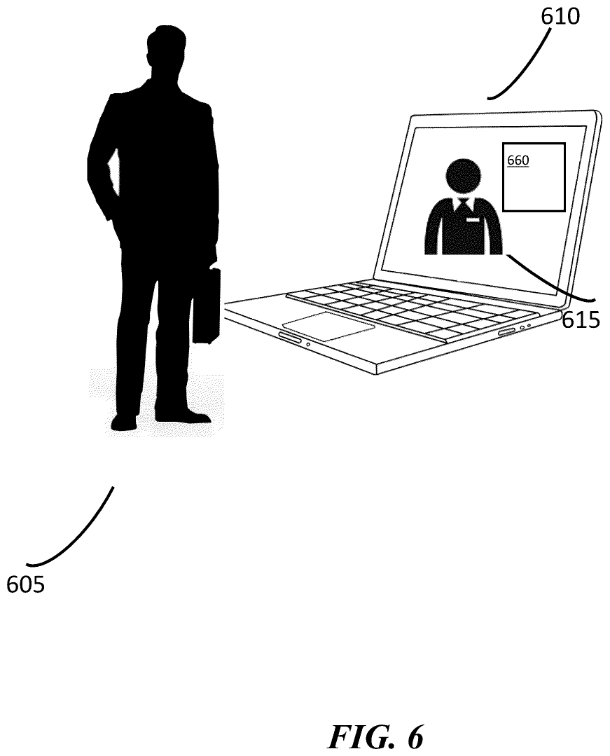

FIG. 6 is a diagram showing a first example of a method according to some embodiments of the present disclosure.

In some embodiments, a user 605 can approach a smart display 610. In some embodiments, the smart display 610 could be LED or OLED-based. In some embodiments, the display 610 could be a part of a desktop computer, a laptop computer, or a tablet computer. In some embodiments, a camera, sensor, and microphone are attached to the smart display 610. In some embodiments, an artificial intelligence visual assistant 615 with customer-facing duty is active on the smart display 610. In some embodiments, the artificial intelligent agent 615 may help in generating real-time voice with AI. In some embodiments, a leading visual agent is guiding the artificial intelligence visual assistant with customer-facing duty 615 without the knowledge of the artificial intelligence visual assistant with customer-facing duty 615. In some embodiments, a visual working agenda 660 is shown on the smart display 610. In some embodiments, user 605 can approach the smart display 610 and initiate and complete the business process with the visual assistant 615 by the methods described in FIG. 1-FIG. 5. In some embodiments, a keyboard is coupled to a central processor. In some embodiments, a keyboard is coupled to a server via a wireless link. In some embodiments, user 605 can interact with the visual assistant 615 via a camera, sensor and microphone using methods described in FIG. 1-FIG. 5, with the help of the keyboard. In some embodiments, user 605 can choose what language to use. In some embodiments, other users can use this service descripted in this paragraph. In some embodiments, other users can use this service described in this paragraph. In some embodiments, the user can interact with multiple AI visual assistants as described in this example and the system and methods described in FIG. 1-5.

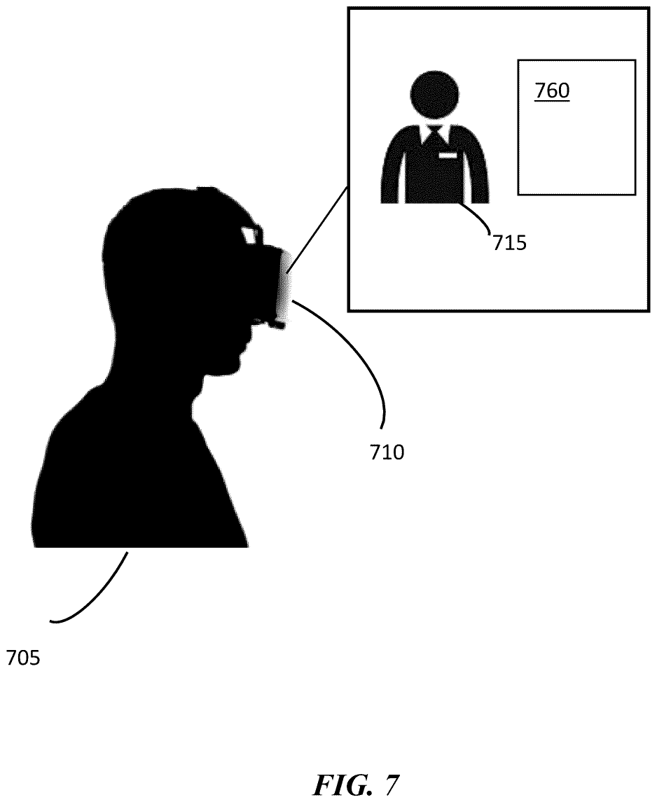

FIG. 7 is a diagram showing a second example of a method according to some embodiments of the present disclosure.

In some embodiments, a user 705 can view programs including news with a VR or AR device 710. In some embodiments, a processor and a server are connected to the VR or AR device 710. In some embodiments, an interactive keyboard is connected to the VR or AR device 710. In some embodiments, an AI visual assistant 715 with customer-facing duty is active on the VR or AR device 710. In some embodiments, a leading visual agent is guiding the AI visual assistant with customer-facing duty 715 without the knowledge of the AI visual assistant with customer-facing duty 715. In some embodiments, the artificial intelligent agent 715 may help in generating real-time voice with AI. In some embodiments, a visual working agenda 760 is shown on the VR or AR 710. In some embodiments, user 705 can initiate and complete the business process with the visual assistant 705 via the VR or AR device 715 by the methods described in FIG. 1-FIG. 5. In some embodiments, an interactive panel is coupled to a central processor. In some embodiments, an interactive panel is coupled to a server via a wireless link. In some embodiments, the user 705 can choose what language to use. In some embodiments, other users can use this service described in this paragraph. In some embodiments, other users can use this service described in this paragraph. In some embodiments, the user can interact with multiple AI visual assistants as described in this example and the system and methods described in FIG. 1-5.

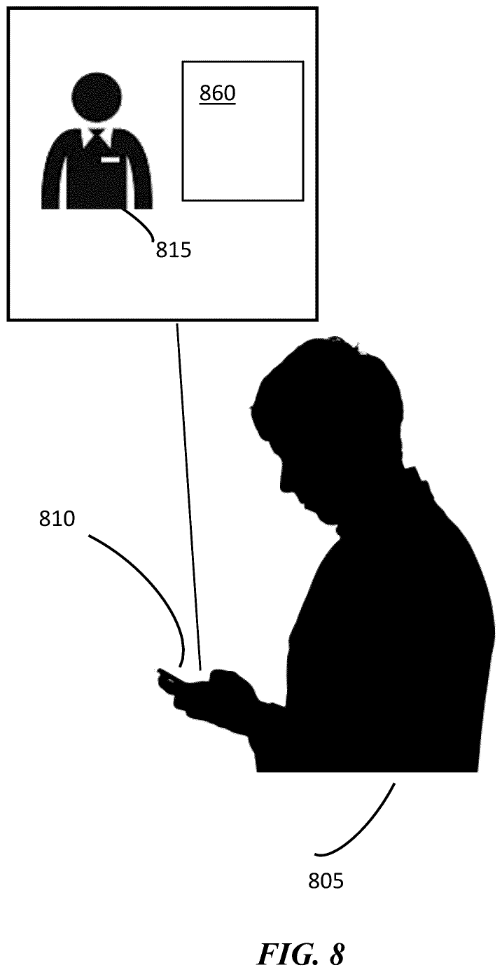

FIG. 8 is a diagram showing a third example of a method according to some embodiments of the present disclosure.

In some embodiments, a user 805 can view programs including news with a smartphone device 810. In some embodiments, a processor and a server are connected to the smartphone device 810. In some embodiments, an interactive keyboard is connected to the smartphone device 810. In some embodiments, an AI visual assistant 815 with customer-facing duty is active on the smartphone device 810. In some embodiments, a leading visual agent is guiding the AI visual assistant with customer-facing duty 815 without the knowledge of the AI visual assistant with customer-facing duty 815. In some embodiments, the artificial intelligent agent 815 may help in generating real-time voice with AI. In some embodiments, a visual working agenda 860 is shown on the smartphone device 810. In some embodiments, user 805 can initiate and complete the business process with the visual assistant 815 via smartphone device 810 by the methods described in FIG. 1-FIG. 5. In some embodiments, an interactive panel is coupled to a central processor. In some embodiments, interactive panel is coupled to a server via a wireless link. In some embodiments, the user 805 can choose what language to be used. In some embodiments, other users can use this service descripted in this paragraph. In some embodiments, other users can use this service described in this paragraph. In some embodiments, the user can interact with multiple AI visual assistants as described in this example and the system and methods described in FIG. 1-5.

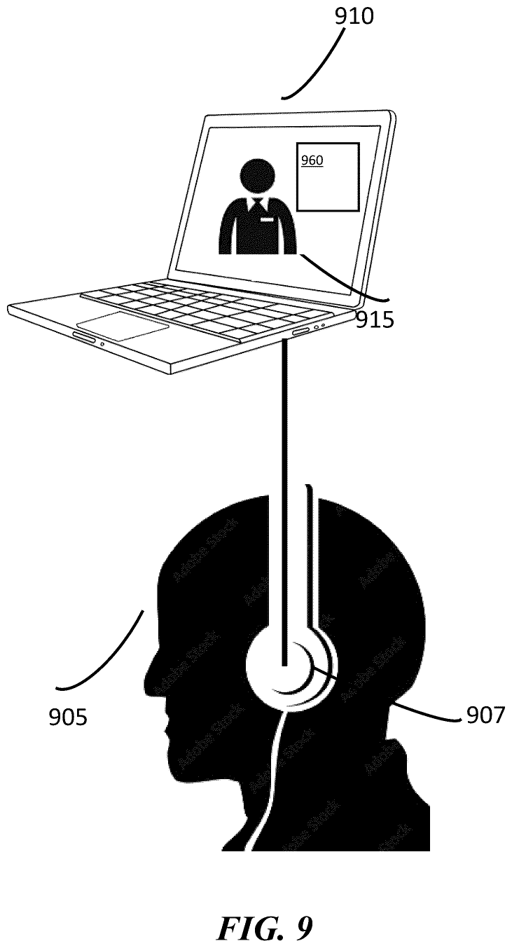

FIG. 9 is a diagram showing a fourth example of a method according to some embodiments of the present disclosure.

In some embodiments, a user 905 has a brain-computer interface. In some embodiments, the user 905 may wear a headset 907 that can detect and translate the electric signal from the brain and communicate with the computer or other devices. The computer 910 or other devices relate to a cable or wire to the headset. In some embodiments, a processor and a server are connected to the computer 910. In some embodiments, an interactive keyboard is connected to the computer 910. In some embodiments, an AI visual assistant 915 with customer-facing duty is active on the computer 910. In some embodiments, the artificial intelligent agent 915 may help in generating real-time voice with AI. In some embodiments, a leading visual agent is guiding the AI visual assistant with customer-facing duty 915 without the knowledge of the AI visual assistant with customer-facing duty 915. In some embodiments, a visual working agenda 960 is shown on the computer 910. In some embodiments, user 905 can initiate and complete the business process with the visual assistant 905 via the computer 915 by the methods described in FIG. 1-FIG. 5. In some embodiments, an interactive panel is coupled to a central processor. In some embodiments, an interactive panel is coupled to a server via a wireless link. In some embodiments, the user 905 can choose what language to use. In some embodiments, other users can use this service descripted in this paragraph. In some embodiments, other users can use this service described in this paragraph. In some embodiments, the user can interact with multiple AI visual assistants as described in this example and the system and methods described in FIG. 1-5.

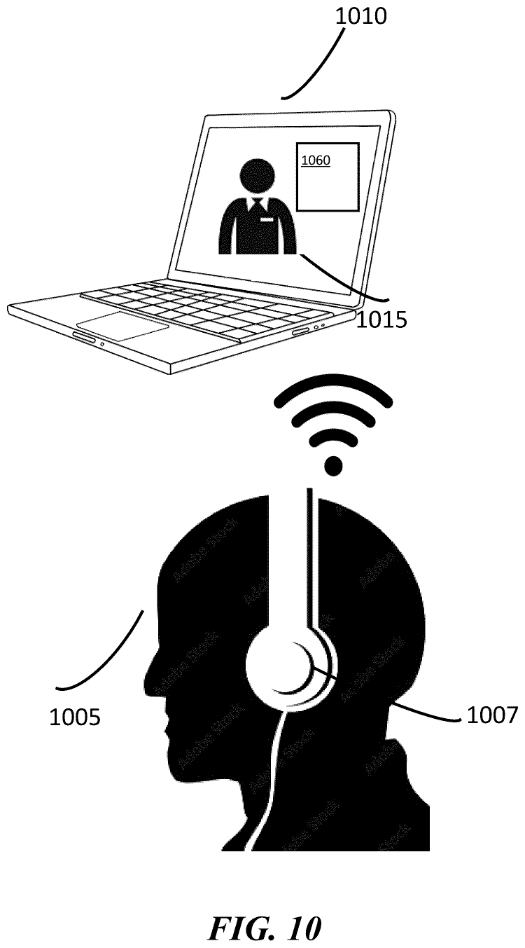

FIG. 10 is a diagram showing a fifth example of a method according to some embodiments of the present disclosure.

In some embodiments, a user 1005 has a brain-computer interface. In some embodiments, the user 1005 may wear a headset 1007 that can detect and translate the electric signal from the brain and communicate with the computer or other devices. The computer 1010 or other devices relate to wireless means to the headset. In some embodiments, a processor and a server are connected to the computer 1010. In some embodiments, an interactive keyboard is connected to the computer 1010. In some embodiments, an AI visual assistant 1015 with customer-facing duty is active on the computer 1010. In some embodiments, a leading visual agent is guiding the AI visual assistant with customer-facing duty 1015 without the knowledge of the AI visual assistant with customer-facing duty 1015. In some embodiments, the artificial intelligent agent 1015 may help in generating real-time voice with AI. In some embodiments, a visual working agenda 1060 is shown on the computer 1010. In some embodiments, user 1005 can initiate and complete the business process with the visual assistant 1005 via the computer 1015 by the methods described in FIG. 1-FIG. 5. In some embodiments, an interactive panel is coupled to a central processor. In some embodiments, an interactive panel is coupled to a server via a wireless link. In some embodiments, the user 1005 can choose what language to use. In some embodiments, other users can use this service descripted in this paragraph. In some embodiments, other users can use this service described in this paragraph. In some embodiments, the user can interact with multiple AI visual assistants as described in this example and the system and methods described in FIG. 1-5.

1. A real-time voice generator system with generative artificial intelligence (AI), comprising:
a processor;
a multi-modal user interface input unit coupled to the processor, wherein the multi-modal user interface input unit is configured to receive various types of inputs, wherein the various types of inputs comprise one or more of a first set of characteristics, wherein the one or more of the first set of characteristics comprise text prompts, voice personality descriptions, images, existing voice samples, documents and websites, videos, and multi-language personality profiles, wherein the text prompts are configured to describe desired voice characteristics, wherein the voice personality descriptions are configured to describe one or more of a second set of characteristics, wherein the one or more of the second set of characteristics comprise tone, pitch, accent, and gender, wherein the documents and websites are configured to match voice to content tone in the documents and websites, wherein the various types of inputs comprise contextual inputs such as language, intonation, and mood to further refine the generated voice;
a real-time voice synthesis engine coupled to the processor, wherein the real-time voice synthesis engine is configured to analyze the various types of inputs and apply a generative AI model to synthesize a synthesized voice based on the various types of inputs, wherein the real-time voice synthesis engine is configured to create novel voice outputs by manipulating fundamental voice characteristics, wherein the processor is configured to transform the synthesized voice into an audio file or stream for real-time or post-generation playback, wherein the synthesized voice is configured to be customized and fine-tuned real-time based on user feedback and changing requirements;
a voice persona creation engine coupled to the processor, wherein the voice persona creation engine is configured to define comprehensive voice profiles based on utility, objective, target audience, and tone;
a voice mixing engine coupled to the processor, wherein the voice mixing engine is configured to mix and combine multiple high-quality base voices from multiple characters;
a vector embedding system coupled to the processor, wherein the vector embedding system is configured to make precise adjustments to voice parameters;
an observable voice system coupled to the processor, wherein the observable voice system coupled to the processor is configured to enable real-time monitoring and modification of voice outputs; and
a feedback mechanism that adjusts the generated voice based on user corrections or preferences provided after an initial voice is synthesized.

2. The real-time voice generator system with generative artificial intelligence of claim 1, wherein the synthetic voice can be integrated into multimedia applications, virtual assistants, or live interactions with users in real-time.

3. The real-time voice generator system with generative artificial intelligence of claim 1, wherein the synthesized voice is automatically optimized for different output devices, including mobile, desktop, and smart speakers.

4. A method with generative artificial intelligence (AI) for generating a synthetic voice from various types of inputs from one or more users:
Receiving the various types of inputs from the one or more users via an user interface, wherein the various types of inputs comprise one or more of a first set of characteristics, wherein the one or more of the first set of characteristics comprise text prompts, voice personality descriptions, images, existing voice samples, documents and websites, videos and multi-language personality profiles, wherein the text prompts are configured to describe desired voice characteristics, wherein the voice personality descriptions are configured to describe one or more of a second set of characteristics, wherein the one or more of the second set of characteristics comprise tone, pitch, accent, and gender, wherein the documents and websites are configured to match voice to content tone in the documents and websites, wherein the various types of inputs comprise contextual inputs such as language, intonation, and mood to further refine the generated voice;
Processing the various types of input through a generative AI model trained on a plurality of voices;
Generating a synthetic voice based on the various types of inputs, wherein the synthesized voice is configured to be customized and fine-tuned real-time based on user feedback and changing requirements on the fly, wherein the synthetic voice could come from combing multiple high-quality base voices from multiple characters by the generative AI model; and
Outputting the generated voice in an audio format.

5. The method with generative artificial intelligence (AI) for generating a synthetic voice from various types of inputs from one or more users of claim 4, wherein the voice synthesis engine integrates voice cloning techniques to imitate or blend existing voices with newly synthesized elements.

6. The method with generative artificial intelligence (AI) for generating a synthetic voice from various types of inputs from one or more users of claim 4, further comprising utilizing natural language processing algorithms to infer implicit voice characteristics from complex user prompts.

7. A real-time voice generator system with generative artificial intelligence (AI), comprising:
a processor;
a multi-modal user interface input unit coupled to the processor, wherein the multi-modal user interface input unit is configured to receive various types of inputs, wherein the various types of inputs comprise one or more of a first set of characteristics, wherein the one or more of the first set of characteristics comprise text prompts, voice personality descriptions, images, existing voice samples, documents and websites, videos, and multi-language personality profiles;
a real-time voice synthesis engine coupled to the processor, wherein the real-time voice synthesis engine is configured to analyze the various types of inputs and apply a generative AI model to synthesize a synthesized voice based on the various types of inputs, wherein the real-time voice synthesis engine is configured to create novel voice outputs by manipulating fundamental voice characteristics, wherein the processor is configured to transform the synthesized voice into an audio file or stream for real-time or post-generation playback; and
a feedback mechanism that adjusts the generated voice based on user corrections or preferences provided after an initial voice is synthesized.

8. The real-time voice generator system with generative artificial intelligence of claim 7, wherein the synthetic voice can be integrated into multimedia applications, virtual assistants, or live interactions with users in real-time.

9. The real-time voice generator system with generative artificial intelligence of claim 7, wherein the synthesized voice is automatically optimized for different output devices, including mobile, desktop, and smart speakers.
